(19) United States
(12) Patent Application Publication
(10) Pub. No.: US 2026/0274191 A1
(43) Pub. Date: Sep. 17, 2026

(54) VEHICLE SEAT

(71) Applicants: TOYOTA JIDOSHA KABUSHIKI KAISHA, Aichi-ken (JP); NHK SPRING CO., LTD., Kanagawa (JP); Autoliv Development AB, Vårgårda (SE)

(72) Inventors: Akira KANEKO, Toyota-shi (JP); Hiromi SUGINO, Nagakute-shi (JP); Shingo FUJIMOTO, Yokohama-shi (JP); Kenzo YASUDA, Yokohama-shi (JP); Daisuke TANAKA, Yokohama-shi (JP); Kouichi YAMADA, Yokohama-shi (JP); Kousuke YONEMOCHI, Yokosuka-shi (JP)

(21) Appl. No.: 19/545,016

(22) Filed: Feb. 20, 2026

(30) Foreign Application Priority Data
Mar. 14, 2025 (JP) 2025-041905

(51) Int. Cl. B60R 21/231; B60R 21/207

(52) U.S. Cl. CPC B60R 21/23138; B60R 21/207; B60R 2021/2076; B60R 2021/23146

(57) ABSTRACT

A vehicle seat includes: an inner panel disposed on a front side of a seat back in a seat front-rear direction; an outer panel disposed on a rear side of the seat back in the seat front-rear direction; an inflator disposed near a center of a seat back frame of the seat back in a seat width direction; and a side airbag disposed between the inner panel and the outer panel and along the outer panel from the inflator in a plan view.

### CROSS-REFERENCE TO RELATED APPLICATION

This application claims priority to Japanese Patent Application No. 2025-041905 filed on Mar. 14, 2025. The disclosure of the above-identified application, including the specification, drawings, and claims, is incorporated by reference herein in its entirety.

### BACKGROUND

### 1. Technical Field

The present disclosure relates to a vehicle seat.

### 2. Description of Related Art

Hitherto, there have been known seats in which a side airbag module is mounted on an outer side in a seat width direction on a seat back having a shell structure that supports a seated occupant from all sides (see, for example, Japanese Patent No. 5039344 (JP 5039344 B)).

### SUMMARY

When the side airbag module including an inflator is provided at the outer end of the seat back in the seat width direction, the thickness of the outer end of the seat back in the seat width direction increases. When the thickness of the outer end of the seat back in the seat width direction increases, the expansion of the interior space in which the seat is provided is hindered.

Therefore, an object of the present disclosure is to provide a vehicle seat that can suppress an increase in the thickness of an outer end of a seat back in a seat width direction even when a side airbag is mounted at the outer end of the seat back in the seat width direction.

In order to achieve the above object, a vehicle seat according to a first aspect of the present disclosure includes: an inner panel disposed on a front side of a seat back in a seat front-rear direction; an outer panel disposed on a rear side of the seat back in the seat front-rear direction; an inflator disposed near a center of a seat back frame of the seat back in a seat width direction; and a side airbag disposed between the inner panel and the outer panel and along the outer panel or the inner panel from the inflator in a plan view.

According to the first aspect of the disclosure, the inner panel is disposed on the front side of the seat back in the seat front-rear direction, and the outer panel is disposed on the rear side of the seat back in the seat front-rear direction. The inflator is disposed near the center of the seat back frame of the seat back in the seat width direction, and the side airbag is disposed between the inner panel and the outer panel and along the outer panel and the inner panel from the inflator in the plan view. That is, the inflator is not disposed at the outer end of the seat back in the seat width direction. Therefore, even in a configuration in which the side airbag is mounted on the outer end of the seat back in the seat width direction, an increase in the thickness of the outer end in the seat width direction is suppressed.

In a vehicle seat according to a second aspect of the present disclosure, in the vehicle seat according to the first aspect, a rigidity of the inner panel is higher than a rigidity of the outer panel.

According to the second aspect of the disclosure, the rigidity of the inner panel is higher than the rigidity of the outer panel. Therefore, when the side airbag is inflated and deployed, deformation of the inner panel is suppressed, and movement of the inner panel that would push a seated occupant is suppressed.

In a vehicle seat according to a third aspect of the present disclosure, in the vehicle seat according to the first or second aspect, the inner panel includes a fragile portion configured to bend an outer end of the inner panel in the seat width direction away from the outer panel in the plan view when the side airbag is inflated and deployed.

According to the third aspect of the disclosure, the inner panel includes the fragile portion configured to bend the outer end of the inner panel in the seat width direction away from the outer panel in the plan view when the side airbag is inflated and deployed. Therefore, when the side airbag is inflated and deployed, it can be deployed away from surrounding components such as a door trim. Thus, the deployment space between the side airbag and the surrounding components is increased.

As described above, according to the present disclosure, it is possible to suppress the increase in the thickness of the outer end of the seat back in the seat width direction even when the side airbag is mounted at the outer end of the seat back in the seat width direction.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic sectional plan view showing the internal structure of a seat back of a vehicle seat according to a first embodiment;

FIG. 2 is a schematic sectional plan view showing a state in which a side airbag of the vehicle seat according to the first embodiment is inflated and deployed; and

FIG. 3 is a schematic sectional plan view showing a state in which a side airbag of a vehicle seat according to a second embodiment is inflated and deployed.

### DETAILED DESCRIPTION OF EMBODIMENTS

Hereinafter, embodiments of the present disclosure will be described in detail with reference to the drawings. For convenience of description, the arrow FR and the arrow RH shown as appropriate in the figures indicate a forward direction of a vehicle seat and a rightward direction of the vehicle seat, respectively. When terms indicating directions, i.e., upward and downward, forward and rearward, and rightward and leftward, are used in the following description without any specification, these mean upward and downward of the vehicle seat, forward and rearward of the vehicle seat, and rightward and leftward of the vehicle seat. Further, the right-left direction is synonymous with a seat width direction.

### First Embodiment

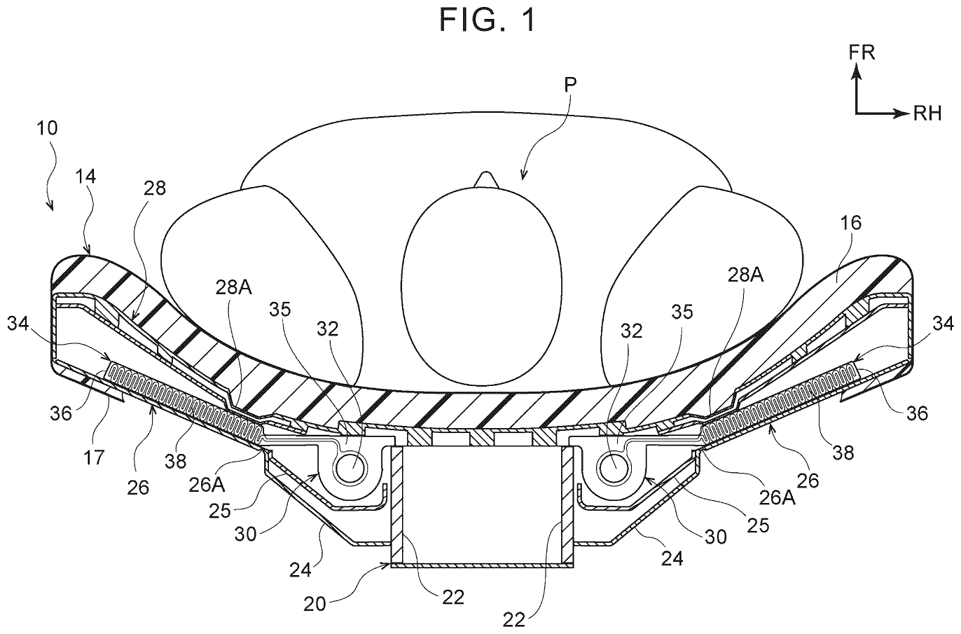

First, a first embodiment will be described. Vehicle seats 10 according to the first embodiment are provided, for example, as seats for an automobile (vehicle), and are installed side by side on the right and left of a floor (not shown) of a vehicle cabin. As shown in FIG. 1, the vehicle seat 10 includes a seat cushion (not shown), a seat back 14 provided at the rear end of the seat cushion, and a headrest (not shown) provided at the center of the upper end of the seat back 14 in the seat width direction.

FIG. 1 shows a state in which a crash test dummy (human dummy) is seated on the seat cushion of the vehicle seat 10 as a model of an occupant (seated person) to be protected. The dummy is, for example, a side crash test dummy (Hybrid III) AM50 (50th percentile for American adult males). Hereinafter, this dummy will be referred to as “occupant P.”

The seat back 14 includes a seat back frame 20 that is symmetrical and extends in an up-down direction at the center of the rear surface (back face) in the seat width direction. The seat back frame 20 includes, in a plan view, a pair of right and left main frames 22 formed in the shape of flat plates with the vehicle width direction as the normal direction, and a pair of right and left cover frames 24 integrally provided on both the right and left sides of the main frames 22. In the following description, when components are symmetrical and provided in pairs on the right and left sides, only one of the right and left components may be described.

The inner end of the cover frame 24 in the seat width direction is integrally connected to the rear end of the outer surface of the main frame 22 oriented outward in the seat width direction, and the cover frame 24 is inclined forward and outward in the seat width direction in a plan view. An outer panel 26 is integrally provided at the outer end of the cover frame 24 in the seat width direction via a thin portion 26A with reduced thickness. The outer panel 26 is also inclined forward and outward in the seat width direction in a plan view. That is, the cover frame 24 and the outer panel 26 are continuously inclined forward and outward in the seat width direction in a plan view.

An inner panel 28 is provided in front of the seat back frame 20 (main frames 22 and cover frames 24) and the outer panels 26. The inner panel 28 is formed in a substantially arcuate (curved) shape in a plan view such that the back of the occupant P is supported over the entire surface via a cover 17 and a seat back pad 16 described later. That is, the seat back 14 has a shell structure in which the seat back frame 20 and the outer panels 26 are disposed on the rear side and the inner panel 28 is disposed on the front side.

The rigidity of the inner panel 28 is set higher than the rigidity of the outer panel 26. For example, as shown in the figure, the inner panel 28 has a double structure formed by joining two panels together at the front and rear, or the thickness of the inner panel 28 is set larger than the thickness of the outer panel 26, thereby increasing the rigidity of the inner panel 28.

The seat back pad 16 is disposed on the front surface of the inner panel 28. The seat back pad 16 is made of, for example, urethane foam, and the cover 17 is provided from the front surface of the seat back pad 16 to the outer ends of the outer panels 26 in the seat width direction. In the illustrated example, the seat back pad 16 is integrally joined to the back surface of the cover 17, but the present disclosure is not limited to this configuration.

Side airbag modules 30 are each disposed between each of the cover frame 24 and the outer panel 26 and the inner panel 28. Specifically, an inflator 32 is disposed forward of each cover frame 24 and rearward of the inner panel 28 at the bottom of the seat back 14, i.e., near the center of the seat back frame 20 in the seat width direction (inward of a side airbag 38 described later in the seat width direction).

Each inflator 32 is formed in a substantially cylindrical shape and is disposed such that its axial direction is in the up-down direction. A side airbag case 34 is provided above each inflator 32 to house and hold the side airbag 38 folded in an accordion shape. A cover member 25 that covers the side airbag case 34 is provided forward of each cover frame 24.

Each cover member 25 is also inclined forward and outward in the seat width direction in a plan view, and its inner end in the seat width direction is bent forward in a plan view to face the outer surface of the main frame 22. The outer end of each cover member 25 in the seat width direction is laid on and joined to the outer end of each cover frame 24 in the seat width direction from the inner side in the seat width direction.

The side airbag case 34 includes an inner case 35 that faces the rear surface of the inner panel 28, and an outer case 36 that extends from the outer end of the inner case 35 in the seat width direction along the front surface of the outer panel 26 in a plan view. The side airbag 38 folded in an accordion shape is housed and held in the inner case 35 and the outer case 36. That is, the side airbag 38 is disposed between the inner panel 28 and the outer panel 26 and along the outer panel 26 from the inflator 32 in a plan view.

The outer case 36 is fully open at the top, bottom, and rear sides, and the side airbag 38 folded in an accordion shape is held between the outer case 36 and the outer panel 26 from the front and rear. A connection port (not shown) provided at the lower end of the side airbag 38 on the inner side in the seat width direction is communicatively connected to an outlet (not shown) provided at the top of the inflator 32. Gas discharged from the inflator 32 is instantly supplied to the side airbag 38.

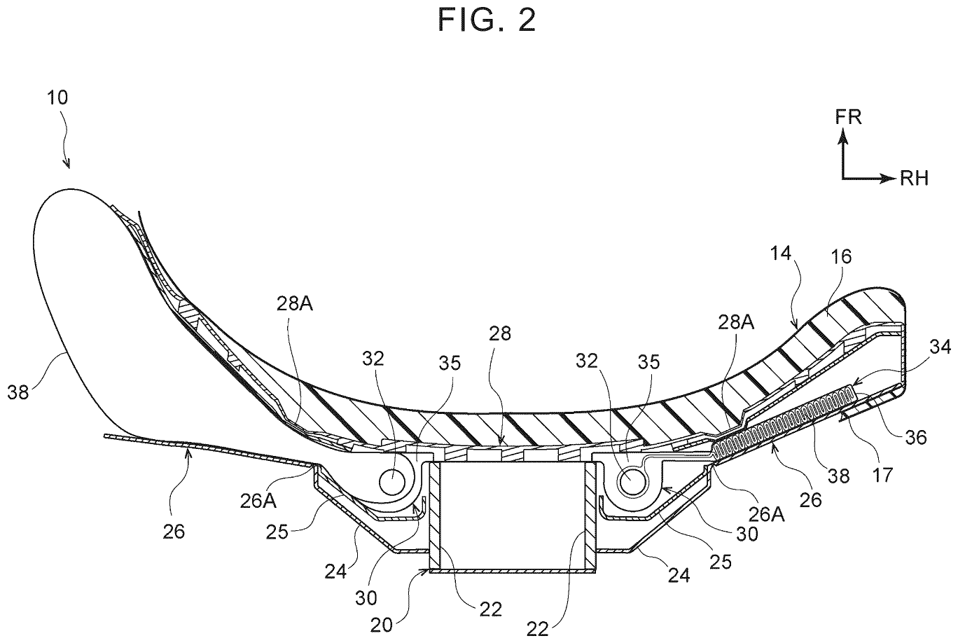

As described above, the inner end of the outer panel 26 in the seat width direction is integrally connected to the outer end of the cover frame 24 in the seat width direction via the thin portion 26A. Therefore, as shown in FIG. 2, the outer end of the outer panel 26 in the seat width direction can move rearward in a plan view with the thin portion 26A serving as a pivot point.

The inner panel 28 also includes a thin portion 28A (portion with reduced thickness) extending in the up-down direction at a position that is approximately the same in the right-left direction as the position of the outer end of the cover frame 24 in the seat width direction. Therefore, as shown in FIG. 2, the outer end of the inner panel 28 in the seat width direction can move forward in a plan view with the thin portion 28A serving as a pivot point.

That is, when the side airbag 38 is inflated and deployed as shown in FIG. 2, the outer end of the outer panel 26 in the seat width direction and the outer end of the inner panel 28 in the seat width direction (including the outer case 36) move away from each other in a plan view. The side airbag 38 is inflated and deployed forward (forward and outward in the seat width direction) from the side of the seat back 14 while being sandwiched from the front and rear.

The side airbag 38 functions as a near side airbag on the outer side in the vehicle width direction, and as a far side airbag on the inner side in the vehicle width direction. Therefore, in the vehicle seats 10 provided side by side in the vehicle cabin, one of the right and left side airbags 38 (near side airbag or far side airbag) is inflated and deployed depending on the type of side collision.

A tearable portion (not shown) that can be torn by a force applied in the front-rear direction is formed at part of the cover 17 that covers the outer end of the outer panel 26 in the seat width direction. That is, this tearable portion is torn by the outer end of the outer panel 26 in the seat width direction that moves rearward as the side airbag 38 is inflated and deployed.

Next, the effect of the vehicle seat 10 according to the present embodiment having the above configuration will be described.

As described above, the inner panel 28 is disposed on the front side of the seat back 14, and the outer panel 26 is disposed on the rear side of the seat back 14. The inflator 32 is disposed near the center of the seat back frame 20 of the seat back 14 in the seat width direction, and the side airbag 38 is disposed between the inner panel 28 and the outer panel 26 and along the outer panel 26 from the inflator 32 in a plan view.

That is, the inflator 32 is not disposed at the outer end of the seat back 14 in the seat width direction, and the side airbag 38 is disposed to extend substantially along the seat width direction in a plan view. Therefore, even in a configuration in which the side airbag 38 is mounted on the outer end of the seat back 14 in the seat width direction, an increase in the thickness of the outer end in the seat width direction can be suppressed. Thus, the space inside the vehicle cabin can be expanded.

When the side airbag 38 is inflated and deployed, the outer end of the outer panel 26 in the seat width direction and the outer end of the inner panel 28 in the seat width direction move away from each other in a plan view, and the side airbag 38 is sandwiched from the front and rear. Therefore, the outer end of the outer panel 26 in the seat width direction and the outer end of the inner panel 28 in the seat width direction serve as guides for the inflated and deployed side airbag 38. Thus, the side airbag 38 can be inflated and deployed forward and outward in the seat width direction as intended.

The rigidity of the inner panel 28 is set higher than the rigidity of the outer panel 26. Therefore, when the side airbag 38 is inflated and deployed, the impact can be released toward the outer panel 26, and forward deformation of the inner panel 28 can be suppressed. Thus, it is possible to suppress movement of the inner panel 28 that would push the occupant P seated in the vehicle seat 10 forward.

As described above, the side airbag 38 folded in an accordion shape is held between the outer case 36 and the outer panel 26 from the front and rear. Therefore, the structure around the seat back frame 20 (main frame 22 and cover frame 24) can be simplified, an increase in the weight of the vehicle seat 10 can be suppressed, and the manufacturing cost can be reduced.

### Second Embodiment

Next, a second embodiment will be described. The same parts as those in the first embodiment are designated by the same reference signs, and detailed description thereof (including common operations) will be omitted as appropriate.

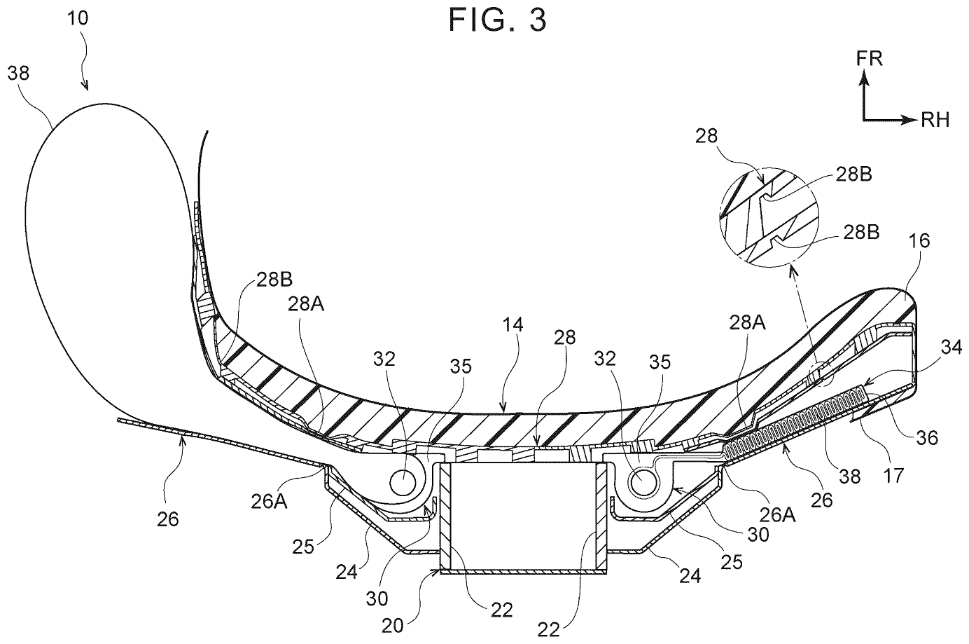

As shown in FIG. 3, the second embodiment differs from the first embodiment only in that the inner panel 28 includes a fragile portion 28B for bending the outer end of the inner panel 28 in the seat width direction away from the outer panel 26 in a plan view when the side airbag 38 is inflated and deployed. The fragile portion 28B is, for example, a thin portion with a reduced thickness, and is formed on the inner side in the seat width direction relative to the outer end of the inner panel 28 in the seat width direction.

When the fragile portion 28B is formed on the inner side in the seat width direction relative to the outer end of the inner panel 28 in the seat width direction and the side airbag 38 is inflated and deployed, the outer end of the inner panel 28 in the seat width direction can be deployed away from surrounding components (not shown) such as a door trim of the side door. Thus, the deployment space between the inner panel 28 and the surrounding components can be increased. That is, with this configuration, the side airbag 38 can be inflated and deployed forward and outward in the seat width direction as intended earlier and more smoothly than in the first embodiment.

The vehicle seat 10 according to the present embodiment has been described above with reference to the drawings, but the vehicle seat 10 according to the present embodiment is not limited to the illustrated embodiment and its design can be changed as appropriate within the scope of the present disclosure. For example, the side airbag 38 folded in an accordion shape may be disposed along the rear surface of the inner panel 28 instead of along the front surface of the outer panel 26. In this case, the outer case 36 has a shape in which the top, bottom, and front sides are fully open.

In the above embodiment, the vehicle seat 10 is described as being applied to a seat in an automobile (vehicle), but the vehicle seat 10 according to the present embodiment can also be applied to seats in vehicles other than automobiles (vehicles), such as ships with the possibility of a side collision.

What is claimed is:

1. A vehicle seat comprising:
an inner panel disposed on a front side of a seat back in a seat front-rear direction;
an outer panel disposed on a rear side of the seat back in the seat front-rear direction;
an inflator disposed near a center of a seat back frame of the seat back in a seat width direction; and
a side airbag disposed between the inner panel and the outer panel and along the outer panel or the inner panel from the inflator in a plan view.

2. The vehicle seat according to claim 1, wherein a rigidity of the inner panel is higher than a rigidity of the outer panel.

3. The vehicle seat according to claim 1, wherein the inner panel includes a fragile portion configured to bend an outer end of the inner panel in the seat width direction away from the outer panel in the plan view when the side airbag is inflated and deployed.
